(19) United States
(12) Patent Application Publication
(10) Pub. No.: US 2013/0304570 A1
(43) Pub. Date: Nov. 14, 2013

(54) METHODS AND SYSTEMS FOR ONLINE PROMOTION ENGAGEMENT NETWORK

(71) Applicants: Micah Johnson, San Diego, CA (US); John Klearman, Ramona, CA (US)

(72) Inventors: Micah Johnson, San Diego, CA (US); John Klearman, Ramona, CA (US)

(73) Assignee: Chief Ingredient, Inc., San Diego, CA (US)

(21) Appl. No.: 13/467,875

(22) Filed: May 9, 2012

(51) Int. Cl. G06Q 30/02

(52) U.S. Cl. 705/14.45; 705/14.73; 705/14.66; 705/14.72

(57) ABSTRACT

Methods and systems for an online promotion driven engagement network are disclosed. In one aspect, information that is received from entrants and consumers upon entry in a promotion is stored in a database. The entrants and consumers are provided access information for generating a profile that includes the stored information. Based on the stored information and additional information provided by the entrants and consumers, online relationship recommendations are generated and communicated to the entrants and consumers. The relationship recommendations can include relationships with other entrants and consumers and/or with advertisers, sponsors, or online communities.

### TECHNICAL FIELD

The technical field relates to systems and methods for engaging in online interactions.

### BACKGROUND

Online promotions are utilized by advertisers to generate interest in particular products or services and increase brand recognition. Upon entering an online promotion, consumers generally provide contact information and identification information for an opportunity to receive a reward (e.g., win a contest, receive free products or services, etc.). Promotions may include contests, sweepstakes, participant generated multimedia competitions, instant win games, participant interactive games

### SUMMARY

According to one aspect, an online promotion driven networking method is disclosed. The method includes generating an online promotion, receiving information related to the online promotion regarding a plurality of promotion participants, the promotion participants comprising a promotion entrant, an advertiser, or a sponsor, storing the received information in a database, correlating, via a computer processor, the stored information, establishing online relationships between at least a subset of the plurality of participants, and storing information indicative of the online relationships in the database.

According to another aspect, an apparatus for online promotion driven networking is disclosed. The apparatus includes a database, and a computer processor configured to generate an online promotion, receive information related to the online promotion regarding a plurality of promotion participants, the promotion participants comprising a promotion entrant, an advertiser, or a sponsor, store the received information in the database, correlate the stored information, establish online relationships between at least a subset of the plurality of participants, and store information indicative of the online relationships in the database.

According to another aspect, a computer program product for processing data for a program configured to generate an online promotion driven network is disclosed. The computer program product includes a non-transitory computer-readable medium having stored there code for causing processing circuitry to generate an online promotion, receive information related to the online promotion regarding a plurality of promotion participants, the promotion participants comprising a promotion entrant, an advertiser, or a sponsor, store the received information in a database, correlate the stored information, establish online relationships between at least a subset of the plurality of participants, and store information indicative of the online relationships in the database.

According to another aspect, a system for online promotion driven networking is disclosed. The system includes means for generating an online promotion, means for receiving information related to the online promotion regarding a plurality of promotion participants, the promotion participants comprising a promotion entrant, an advertiser, or a sponsor, means for storing the received information in a database, means for correlating the stored information, means for establishing online relationships between at least a subset of the plurality of participants, and means for storing information indicative of the online relationships in the database.

### BRIEF DESCRIPTION OF THE DRAWINGS

Some embodiments will be described in conjunction with the appended drawings, where like designations denote like elements.

FIG. 1 illustrates an online promotion driven network system according to at least some embodiments of the present invention.

FIG. 2 illustrates examples of components of the online promotion driven network system of FIG. 1 and an online promotion network according to some embodiments.

FIG. 3A is a flowchart of a method of generating an online promotion according to some embodiments.

FIG. 3B is a flowchart of a method of generating settings for an online promotion according to some embodiments.

FIGS. 4A, 4B, and 4C are flowcharts of a method of interaction by an advertiser and/or sponsor with an online promotion driven engagement network according to some embodiments.

FIGS. 5A, 5B, and 5C are flowcharts of a method of interaction by a consumer with an online promotion driven engagement network according to some embodiments.

FIG. 6 illustrates a graphical user interface for communicating sponsor bid information according to some embodiments.

FIG. 7 illustrates a graphical user interface for communicating sponsor bid notification information according to some embodiments.

FIG. 8A illustrates one example of a graphical user interface for an entrant/consumer.

FIG. 8B illustrates another example of a graphical user interface for an entrant/consumer.

FIG. 9 illustrates examples of components of the online promotion driven network system of FIG. 1 according to some embodiments.

FIG. 10A illustrates an example of an entrant database according to some embodiments.

FIG. 10B illustrates an example of an advertiser/sponsor database according to some embodiments.

FIG. 11A is an example flowchart of a method of utilizing promotion information to generate a promotion driven engagement network according to some embodiments.

FIG. 11B is a flowchart of a method of correlating data to generate recommendations.

FIG. 12A illustrates an example of an entrant/consumer engagement database according to some embodiments.

FIG. 12B illustrates an example of an advertiser/sponsor engagement database according to some embodiments.

FIG. 12C illustrates an example of information retrieved from an entrant/consumer engagement database to generate recommended online relationships.

### DETAILED DESCRIPTION

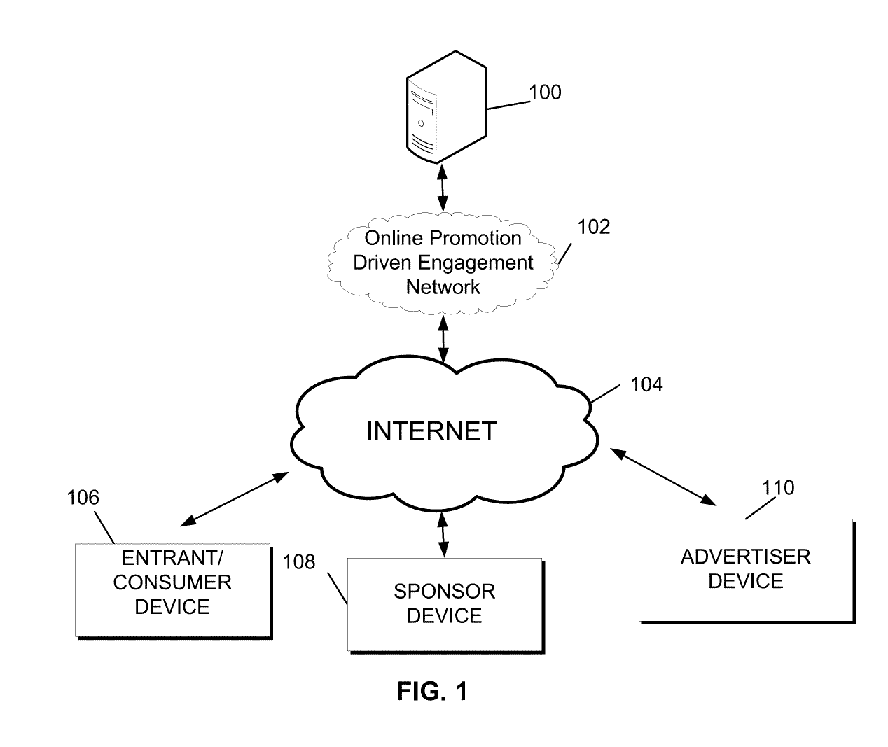

FIG. 1 illustrates an online promotion driven network system according to some embodiments. As shown in FIG. 1, the online promotion driven network system may include a processor 100. The processor 100 may function as a server for hosting an online promotion. As discussed above, online promotions may include contests, sweepstakes, participant generated multimedia competitions, instant win games, participant interactive games, or the like. A promotion participant can include any one of an entrant, a sponsor, or an advertiser.

In some embodiments, the processor 100 is configured to generate an online promotion driven engagement network 102 to enable communication between multiple user devices, and between the processor 100 and the multiple user devices. The online promotion driven engagement network 102 may be similar to a social network where participants are engaged in online social interactions based on established online relationships or links between the participants. For example, user devices that are configured to communicate through the online promotion driven engagement network 102 may include an entrant/consumer device 106, a sponsor device 108, and an advertiser device 110 which are in communication with each other and the processor 100 through the Internet 104 and the online promotion driven engagement network 102.

An advertiser may correspond to an entity which has defined the terms of the online promotion. For example, the advertiser may be a car manufacturer that is hosting an online contest to win a free car. A sponsor corresponds to an entity which is participating in the promotion per an agreement with the advertiser in return for advertisement of the sponsor's product or service. For example, a sponsor may be a tire manufacturer that sponsors an online contest to win a free car which is hosted by a car manufacturer. The sponsor and the car manufacturer may have a financial agreement dictating the terms of participation of the sponsor in the online promotion. An entrant is a participant in the promotion who has provided some identification or contact information in order to participate in the promotion. For example, an entrant may be a person that has entered a contest to win a free car by providing their contact information through the promotion. A consumer corresponds to any entity which is interested in purchasing a product or service. In some embodiments, the consumer may have entered a previous promotion, and may interact with other consumers, entrants, sponsors, or advertisers through the online promotion driven engagement network 102.

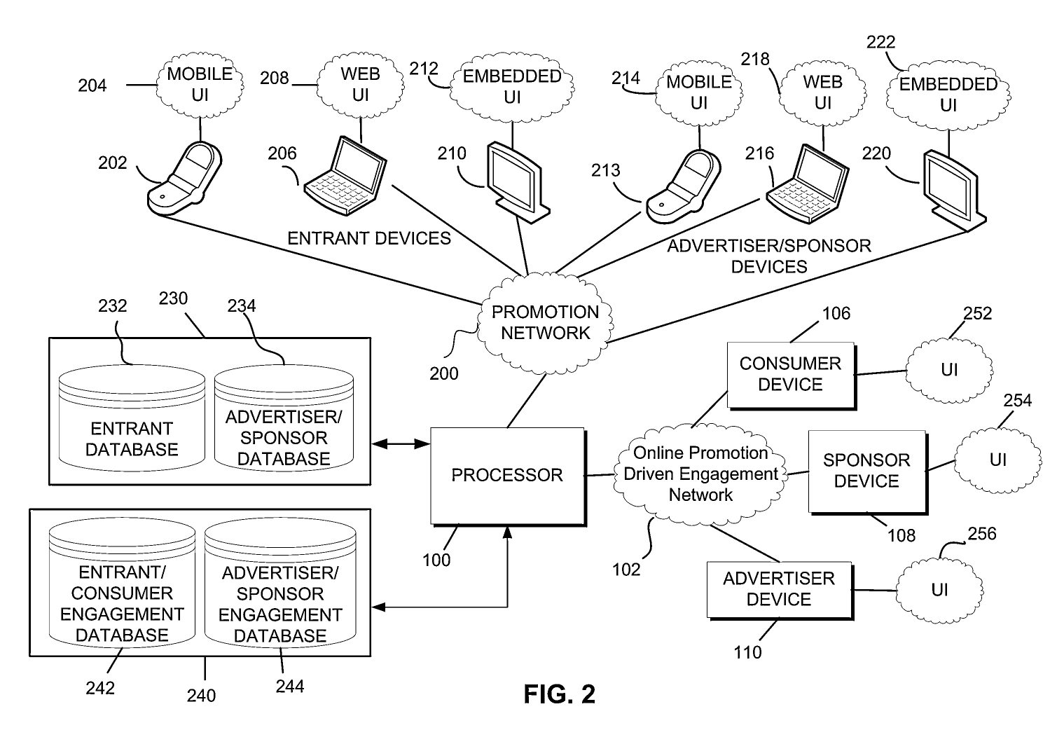

FIG. 2 illustrates examples of components of the online promotion driven network system of FIG. 1 and a promotion network according to some embodiments. As shown in FIG. 2, a plurality of devices may be configured to interact with the processor 100 through the promotion network 200. For example, the devices may include entrant devices 202, 206, and 210. As illustrated, an entrant device may include, for example, a mobile entrant device 202 configured to include a mobile user interface 204 for interaction with the promotion network 200. A mobile entrant device 202 may include, for example, a cell phone, a smart phone, a personal digital assistant (PDA), or the like. Other entrant devices can include a computing device 206 that is configured to communicate with an entrant through a web interface 208 for interaction with the promotion network 200. A computing device 206 may include, for example, a laptop computer, a desktop computer, a tablet, or the like. The web interface may be configured to communicate with the entrant through a web browser to display information, such as textual and graphical information, to an entrant. The web browser may comprise any type of visual display capable of displaying information received via the promotion network 200. An entrant device may also include devices which have an embedded user interface such as embedded user interface 212. For example, as shown in FIG. 2, entrant device can be configured as a terminal 210 that includes the embedded user-interface 212.

The devices interacting with promotion network 200 also include advertiser or sponsor devices 213, 216, and 220. Advertiser or sponsor devices may include a mobile device 213 having a mobile user interface 214, a computing device 216 having a web user interface 218, or a terminal device 220 having an embedded interface 222. The advertiser or sponsor devices and user interfaces may be similar to those described above with reference to the entrant devices. Any of the entrant devices, advertiser devices, and sponsor devices, may also be configured to include one or more of the user interfaces described above.

The processor 100 may be configured to execute instructions to function as a server and communicate with and receive information from the entrant devices, the advertiser devices, and the sponsor devices, through the promotion network 200. Instructions may include computer-implemented steps for processing information in the system. Instructions can be implemented in software, firmware, or hardware and can include any type of functional process that is performed by components of the system. The processor 100 may include, for example, one or more single or multi-chip microprocessors, or the like. Further, the processor 100 may include one or more special purpose microprocessors, such as a digital signal processors, or graphics processors.

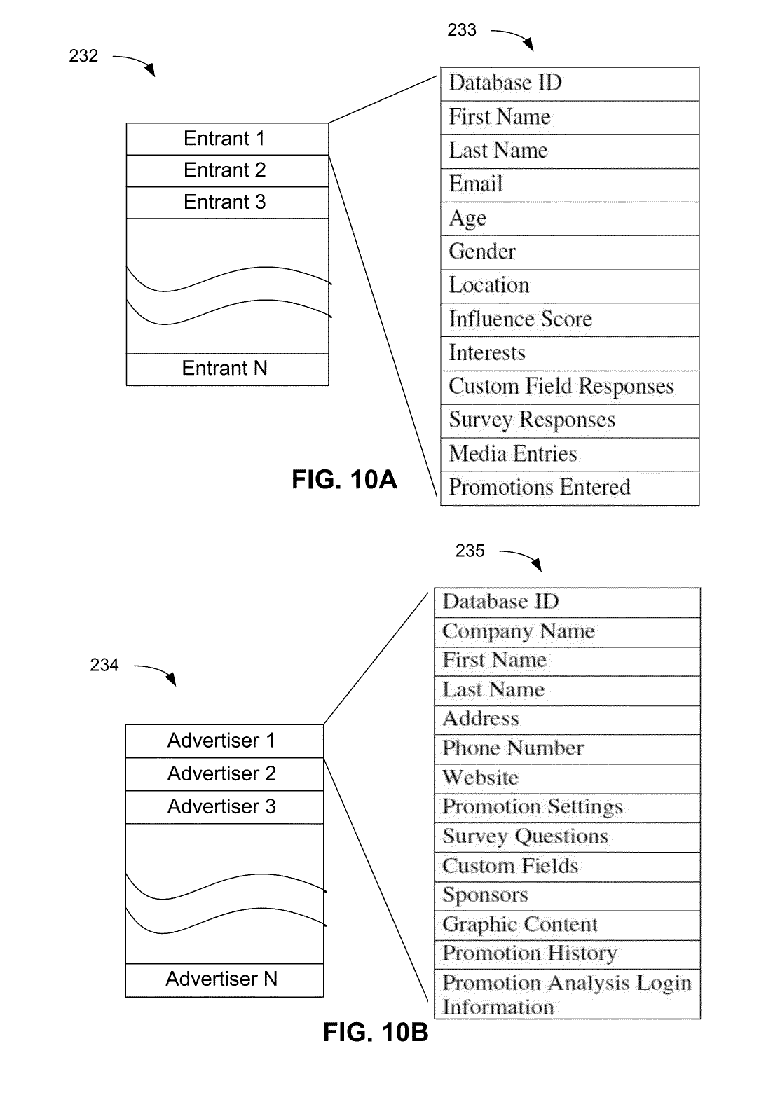

The processor 100 is configured to communicate with a promotion database 230. The promotion database 230 can include an entrant database 232 and advertiser/sponsor database 234. The processor 100 can be configured to store information regarding promotion participants (e.g., entrants, sponsors, or advertisers) in the promotion database 230 as will be described in greater detail below with reference to FIGS. 10A-10B. The processor 100 is also configured to generate an promotion driven engagement network 102 based at least in part on the information in the promotion database 230. The processor 100 communicates with one or more devices, such as consumer device 106, sponsor device 108, or advertiser device 110, through the online promotion driven engagement network 102. While not shown, each of the consumer device 106, the sponsor device 108, and advertiser device 110 may also communicate with the processor 100 through the promotion network 200. For example, a consumer device 106 can be configured to function similarly to an entrant device (e.g., entrant devices 202, 206, and 210) during participation in a promotion through the promotion network 200. Further, one of ordinary skill in the art will recognize that the number and types of devices that are in communication with the processor 100 is not limited to the number and types of devices which are shown in FIG. 2.

The processor 100 is configured to receive information from one or more of the consumer devices 106, the sponsor devices 108, and the advertiser devices 110 through the online promotion driven engagement network 102. The received information can include information regarding promotion participants in addition to the information which is stored in the promotion database 230. For example, the received information can include additional details regarding promotion participants as will be described in greater detail with reference to FIGS. 10A-10B below. The information received through the online promotion driven engagement network 102 is stored by the processor 100 in an engagement database 240. The engagement database 240 can include, for example, an advertiser or sponsor engagement database 244, and an entrant/consumer engagement database 242. The processor 100 may also be configured to analyze the information in the promotion database 230 and/or the engagement database 240, and communicate the information to one or more devices through the promotion network 200 and the online promotion driven engagement network 102.

While shown as separate databases, the promotion database 230 and the engagement database 240 can be provided in a single database that is dynamically updated as additional information is received. For example, as additional information is received through the online promotion driven engagement network 102 the promotion database 230, the engagement database 240, and/or the combined database can be updated. In some embodiments, the databases may be separately provided and entries which correspond to the same participant may be cross-referenced based on a participant database ID.

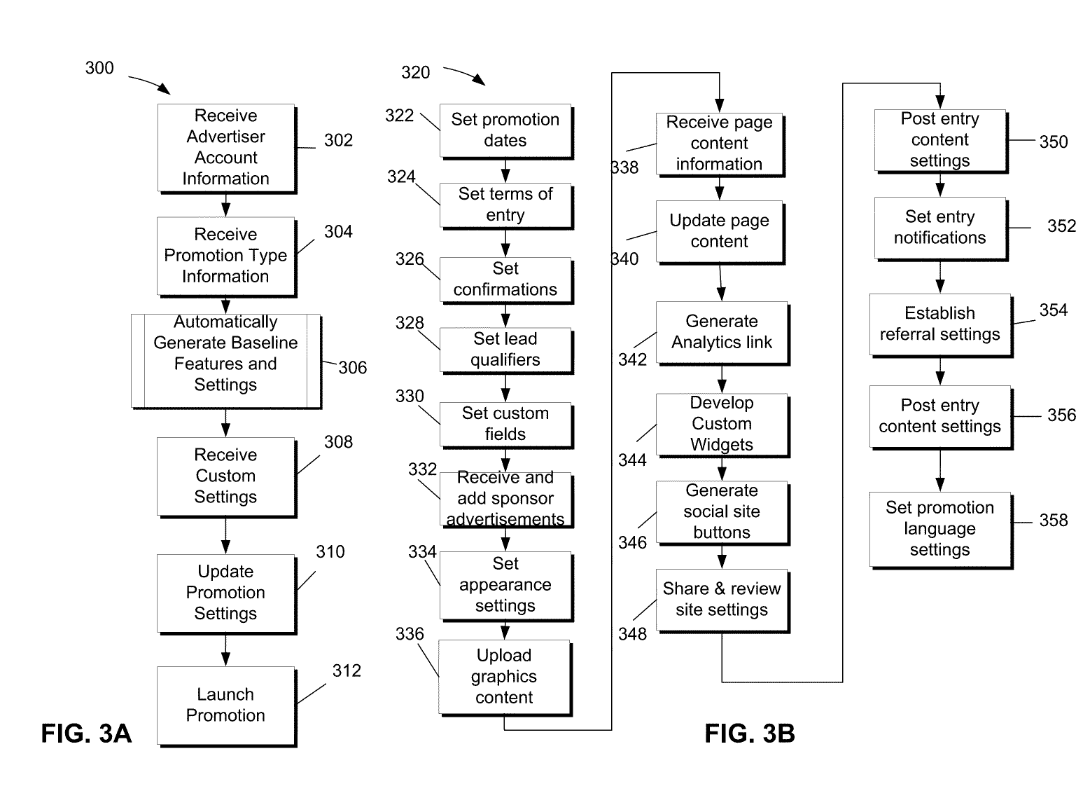

FIG. 3A is a flowchart of a method of generating an online promotion according to some embodiments. The method 300 may be performed by a processor such as processor 100. The method 300 includes receiving advertiser account information as shown in block 302. For example, an advertiser may enter information such as company name and contact information. In some embodiments, the advertiser can be a representative of a number of product or service providers. Upon logging in through the system, the advertiser (acting as a representative) may select a particular company for which a promotion is to be generated from a drop-down list of associated accounts.

Promotion type information may also be received as shown in block 304. For example, an advertiser can select from among different promotion types including contests, sweepstakes, participant generated multimedia competitions, instant win games, participant interactive games, or the like. Based on the received advertiser account information and the received promotion type information, baseline features and settings for the promotion are automatically generated as shown in block 306. For example, baseline features may include generation of an initial turnkey promotion landing page. An initial turnkey promotion landing page may be configured as an adaptable widget that can be implemented in any number of platforms (e.g., mobile device applications, websites, etc.) without additional programming. In some embodiments, the landing pages and other promotion generating software may be built based on a Google® platform. Automatically generated features may also include multi-platform entry forms for the promotion, entrant confirmation communication format and text (e.g., email confirmation to the entrant of the promotion), and initial entrant promotion qualification questions (e.g., first name, last name, contact information). In some embodiments, a multi-platform entry form may be configured as a graphical user interface (GUI) widget that is adaptable to different platforms, such as mobile applications, different websites, or the like. Automatically generated settings may include initialized data enhancement settings such as filtering tools and promotion performance display settings. Further, the automatically generated settings can also include the format and type of entry point codes or referral URLs which are unique to particular entrants and which can be used to provide credit to entrants for referring other entrants to the promotion. In some embodiments, the entry form may enable entrants to automatically generate emails to referrals directly from the entry form by accessing a link.

As shown in block 308, custom settings may be received from the advertiser and the promotion settings may be updated as shown in block 310 based on the received custom settings. For example, the custom settings may be used in order to further refine and build the promotion. The advertiser may elect to edit or customize features of the promotion such as the format and text of the entrant confirmation notification. Further, the advertiser may customize the display features of the promotion landing page. In some embodiments, the advertiser may be provided with a real-time view of the final promotion landing page as the advertiser edits the features of the landing page. For example, the advertiser may change the features of the promotion landing page using, for example, a WYSIWYG editing tool. The WYSIWYG editing tool may be configured to provide different view modes during editing, including, for example, a preview mode which shows how the final landing page will look in final form, and a formatting mode which provides formatting information along with the real-time view of the final landing page.

In some embodiments, an advertiser may provide custom settings regarding features such as review site integration and particular GUI widgets to be enabled for the promotion. For example, an advertiser may elect to integrate a consumer review and comments panel into the promotion. In some embodiments, the advertiser may select to enable various GUI widgets such as a promotion list widget, an activity widget, a sponsorship widget, and a user generated content list widget. The promotion list widget can be integrated to the entry form and can generate dynamic information regarding the promotions that are related to a particular advertiser or product. An activity widget can be integrated into the entry form and can generate real-time information indicative of entrants of the promotion (e.g., “Joe Smith has just entered this promotion!”). The sponsorship widget can be integrated into the entry form and can enable placement of dynamic sponsor advertisements on the entry form. The user generated content list widget can be integrated into the entry form and can provide real-time and dynamic information regarding user generated content that has been entered into a promotion or provided by entrants of the promotion.

Following customization, as shown in block 312, the promotion is launched and entrants are provided access for entering the promotion. In some embodiments, following customization of the promotion and finalization by the advertiser, the promotion settings may be saved for subsequent use by the advertiser. For example, a returning advertiser may select a previously generated promotion and instantly duplicate the promotion or begin with the previously generated promotion settings as the baseline settings.

FIG. 3B is a flowchart of a method of generating settings for an online promotion system according to some embodiments. The method 320, which may be performed by the processor 100, illustrates some examples of the settings which are generated and customized by an advertiser as discussed above with reference to FIG. 3A. While shown sequentially, the steps of the method 320 may be performed in an order different than that shown in FIG. 3B. Further, the method may include additional steps or exclude some of the steps shown in FIG. 3B.

The method 320 can include setting promotion start and end dates as shown in block 322. Terms of entry, such as the number of permissible entries per entrant, may be set as shown in block 324. Confirmation information, such as correspondence type and text, may be set as shown in block 326. Advertiser unique lead qualifiers may be set as shown in block 328. For example, an advertiser can define particular information regarding entrance in order to automatically generate notification of an entrant whose information matches the advertiser defined information. In some embodiments, a promotion may include a survey including advertiser selected questions, and the advertiser may set parameters for selecting an entrant and generating a lead notification to the advertiser based on the survey responses. For example, a car retailer hosting a promotion may set a lead notification for entrants which indicate that they are interested in buying a car in the next three months. In another example, a survey response by an entrant that they would be interested in receiving a brochure may automatically generate a correspondence to a contact designated by the advertiser in order to address the entrant's interest in the advertiser's product or service.

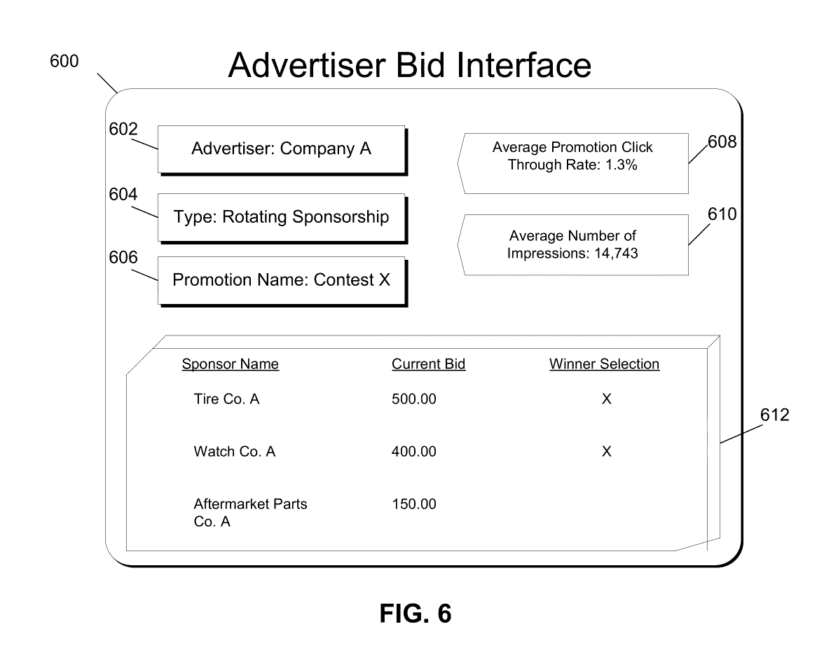

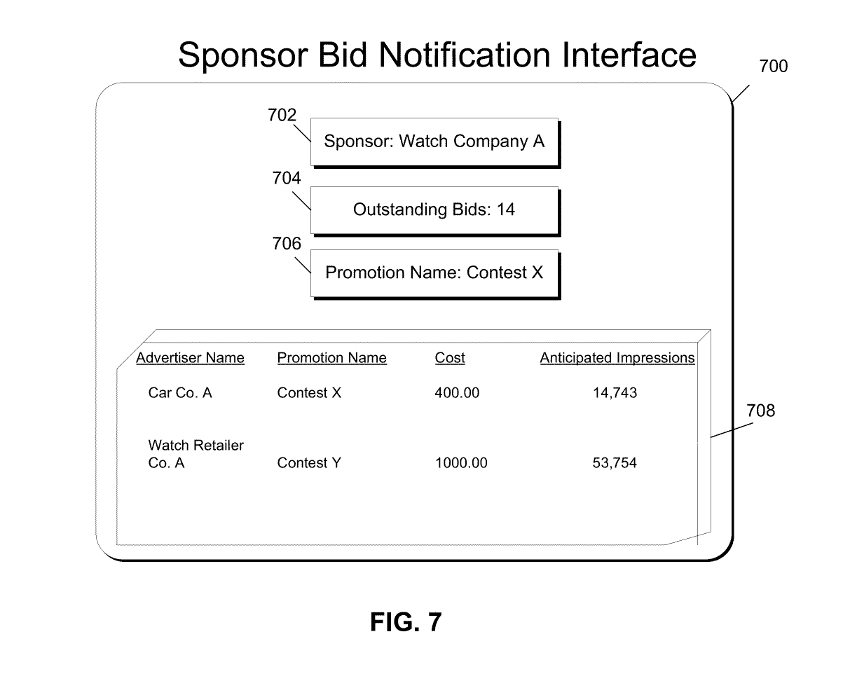

Custom fields for the promotion may be set as shown in block 330. For example, the advertiser can include one or more fields for retrieving additional entrant information such as birthdates, phone numbers, or the like. Sponsor advertisement information may be received and added as shown in block 332. For example, a tire manufacturer may provide a particular advertisement that is to be included in the promotion based on a financial agreement between the advertiser and the sponsor as will be described in greater detail with reference to FIGS. 6-7 below. Other appearance settings, such as promotion page layout and color scheme, may be set by the advertiser as shown in block 334. As discussed above, the appearance settings may be edited using a WYSIWYG editor. Further, additional graphic contents, such as logos, brand specific images, or the like, may be uploaded by the advertiser for integration in the promotion page as shown in block 336.

At block 338, additional page content, such as multimedia content, advertiser product information, and advertiser promotion specific advertisements, may be received from the advertiser. The received page content is used to update the promotion page as shown in block 340. At block 342, an analytics link for the advertiser is generated which enables advertiser access to information regarding the performance of the promotion.

Custom GUI widgets may be generated based on advertiser input as shown in block 344. For example, in some embodiments, a multi-step widget generator may be provided to the advertiser to generated custom widgets for integration with the promotion. At block 346, social site buttons which link the promotion to social media platforms (e.g., Facebook®, Google+®, or the like) may be generated. As shown in block 348, site settings can be shared and reviewed by the advertiser.

At block 350, entry content settings may be set. For example, the advertiser can indicate the type of information that is to be submitted by a potential entrant in order to allow entry and participation in the promotion. The entry content settings can be set to, for example, require basic contact information such as name and email address, or may require additional information such as completion of a survey. At block 352, entry notifications for the promotion may be set. For example, entry notifications may be set by the advertiser to update the advertiser when each entrant has entered the promotion, or when a particular number of entrants have entered the promotion.

At block 354, referral settings may be established for the promotion. The referral settings may dictate the amount of credit (e.g., in the form of additional entries) an entrant receives for referring other entrants to the promotion. For example, the promotion may provide 5 credits for entry by the entrant, 2 credits for each referral, and an additional 10 credits when a user refers 25 entrants. The credits can be used to select a winner of the promotion.

At block 356, the advertiser may set the post entry content of the promotion. For example, post entry content can include additional advertiser content that is available to the entrant upon entry to the promotion. The additional content may be provided to the entrant through the promotion page immediately following entry, or may be sent to the entrant using the contact information which was provided by the entrant upon entry to the promotion.

At block 358, the promotion language setting may be set. For example, the promotion language settings may enable one or more languages for communication of the promotion content with the entrant.

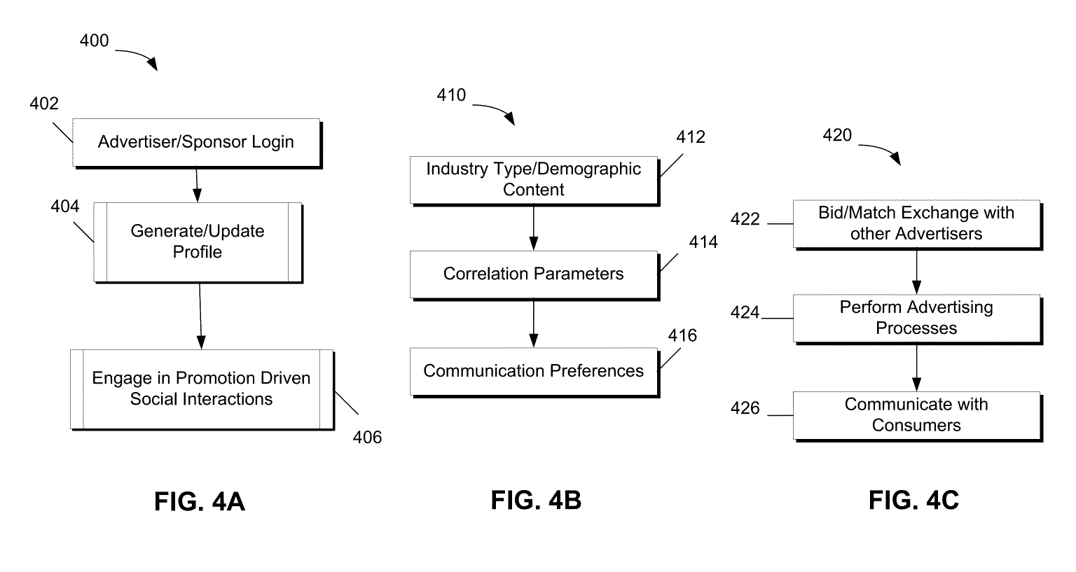

In some embodiments, promotion participants are enabled to have additional engagement opportunities with other promotion participants. The engagement opportunities can include interaction with participants in the same promotion, different ongoing promotions, or previously completed promotions. FIGS. 4A, 4B, and 4C are flowcharts of a method of interaction by an advertiser and/or sponsor with an online promotion driven engagement network 102 according to some embodiments. As shown in the method 400, an advertiser or a sponsor can login through the system as shown in block 402. For example, an advertiser can enter user ID and password information corresponding to the advertiser which grants access to the advertiser's information. At process block 404, the advertiser or sponsor may generate or update a profile. For example, the advertiser or sponsor may create a profile for engaging with the online promotion driven engagement network 102 based on information previously provided during interaction with the promotion. The advertiser or sponsor may also update or add other information to their profile as will be described in greater detail with reference to FIG. 4B. As shown in process block 406, the advertiser or sponsor can engage in promotion driven social interactions, for example, through the promotion driven engagement network 102 as discussed above with reference to FIGS. 1 and 2.

FIG. 4B illustrates an example of a method of generating and updating an advertiser or sponsor profile. The method 410 can correspond to an example of a method corresponding to process block 404 as discussed above with reference to FIG. 4A. Method 410 can include setting industry type/demographic content as shown in block 412. For example, an advertiser or sponsor may indicate that they are a retailer or service provider. The advertiser or sponsor can also set correlation parameters as shown in block 414. For example, the advertiser or sponsor may indicate the type of information regarding other promotion participants that should be matched with the sponsor's or advertiser's preferences. The advertiser or sponsor can also set communication preferences (e.g., email, phone, text, or web messaging) as shown in block 416.

FIG. 4C illustrates examples of a method of engaging in promotion driven social interactions by an advertiser or sponsor. The method 420 can correspond to an example of a method corresponding to process block 406 as discussed above with reference to FIG. 4A. The social interactions can correspond to social interactions which are carried out through the promotion driven engagement network 102 as discussed above.

The method 420 can include engaging in a bidding and/or matching exchange with other advertisers in order to generate sponsorships for different promotions as shown in block 422. For example, as will be discussed in greater detail with reference to FIGS. 6-7, an advertiser can interact with other advertisers or sponsors in order to reach a financial agreement regarding sponsorships for a particular promotion. In some embodiments, the advertiser can utilize promotion planning tools to determine sponsorships, offer different levels of advertisement to be included in a promotion to potential sponsors, and exchange content with sponsors of the promotion. An advertiser can also perform advertising functions as shown in block 424. For example, an advertiser can generate advertisements to be included on an entrant's portal to the network, create sponsor badges corresponding to different accomplishments by entrants, generate offers to be distributed to consumers engaged in the network, and broadcast or publish company information through the promotion driven engagement network 102. The advertisers advertising strategies can be adjusted based on analysis of promotion performance results which are provided to the advertiser, and/or analytical information regarding consumer behavior which are derived through the promotions.

The method 420 can also include communicating directly with consumers through the online promotion driven engagement network 102 as shown in block 426. For example, an advertiser and a consumer may establish a relationship through the promotion driven engagement network 102 based on information derived from participation in promotions. The established relationship can enable direct messaging and communication between the advertiser and the consumer. In some embodiments, a consumer may participate in additional survey or research studies which are communicated to the advertiser. Since the advertiser and the consumer have an established relationship, the consumer may indicate interest in participating in such surveys and research studies, and as a result, the rate of participation by consumers in the surveys and research studies may increase. In some embodiments, hot lead notifications may also be communicated to the advertiser through the network based on interaction of consumers with other network participants. For example, consumers may adjust preference settings and indicate particular products or services of interest, and in turn, a notification may be automatically generated and communicated to an advertiser whose products or services match the parameters which are defined by the consumer.

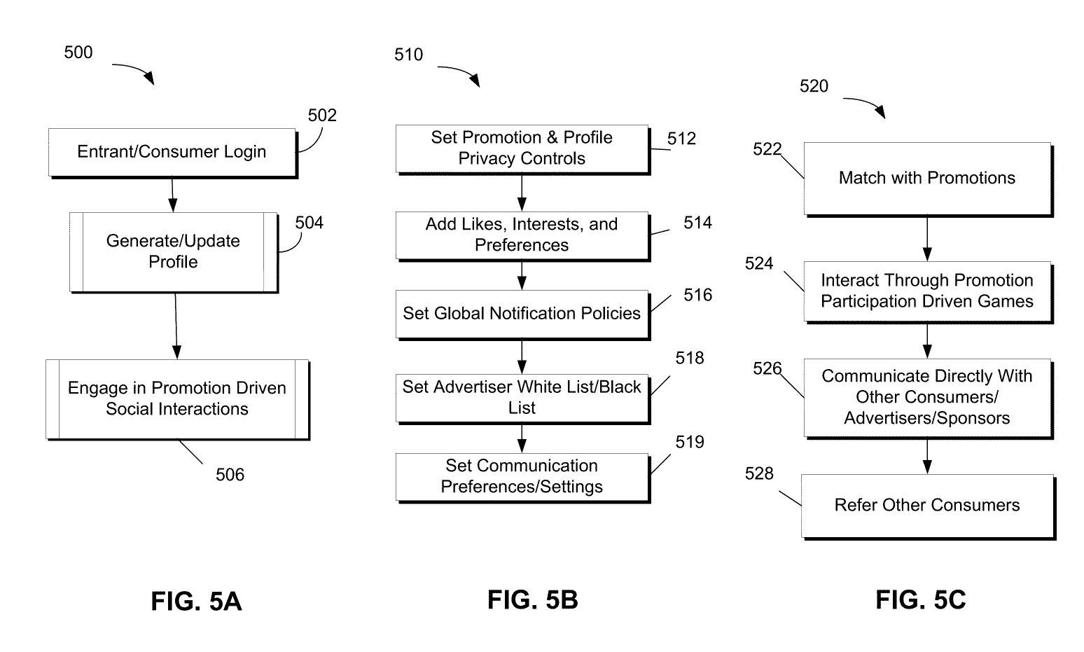

FIGS. 5A, 5B, and 5C are flowcharts of a method of interaction by a consumer with an online promotion driven engagement network according to some embodiments. As shown in the method 500, a consumer can login through the system as shown in block 502. For example, the consumer can enter user ID and password information corresponding to the consumer which grants access to the consumer's information. At process block 504, the consumer may generate or update a profile. For example, the consumer may create a profile for engaging with the online promotion driven engagement network 102 based on information previously provided during interaction with the promotion. The consumer may also update or add other information to their profile as will be described in greater detail with reference to FIG. 5B. As shown in process block 506, the consumer can engage in promotion driven social interactions, for example, through the promotion driven engagement network 102 as discussed above with reference to FIGS. 1 and 2.

FIG. 5B illustrates an example of a method of generating and updating a consumer profile. The method 510 can correspond to an example of process block 504 as discussed above with reference to FIG. 5A. Method 510 can include setting promotion and profile privacy controls. For example, a consumer can indicate the type of information from their profile that they would like to share with network participants. Further, the consumer can define and control the sharing of information which was previously provided through participation in promotions. For example, the consumer can indicate which network participants, if any, can be granted access to survey and promotion participation information which was previously generated. The consumer can also indicate the type of information that was generated through a promotion, or provided directly by the consumer when updating their profile, that can be shared with different network participants. In some embodiments, a consumer can also indicate opt-in information indicating which promotions a consumer wishes to remain entered into, and opt-out information indicating promotions for which the consumer would like to withdraw their entry.

As shown in block 514, a consumer can indicate particular likes, interests, and preferences for different industries, products, or services. For example, a consumer can indicate a particular interest in travel, and particular travel locations that they prefer. As shown in block 516, the consumer can set global notification policies for network interaction. For example, the consumer can indicate the type and format of information they would like to automatically receive from the network based on their interests. As shown in block 518, the consumer can set advertiser white list/black lists. For example, a consumer can include particular companies on a white list, indicating that they are preferred companies. The consumer can also include particular companies on a black list, indicating that they are non-preferred companies. At block 519, the consumer can set communication preferences and settings, for example, email, phone, text, or web messaging.

FIG. 5C illustrates examples of a method of engaging in promotion driven social interactions by a consumer. The method 520 can correspond to an example of a method corresponding to process block 506 as discussed above with reference to FIG. 5A. The social interactions can correspond to social interactions which are carried out through the promotion driven engagement network 102 as discussed above.

As shown in block 522, matching between consumer preferences and other corresponding promotions can be performed. For example, matching can be performed based on promotion recommendations from other consumers in the network or through promotion filters that are set based on consumer preferences. The method 520 can include interaction with promotion participation driven games, as shown in bock 524. For example, promotion driven games can include promotion of the day notifications, as well as badges and status awards for promotion participation. Further, the method 520 can include communicating directly with advertisers, sponsors, and/or other consumers, through the network as shown in block 526. For example, a consumer may establish an online relationship through the promotion driven engagement network 102 based on information derived from participation in promotions. The established online relationship can enable direct messaging and communication between the consumers. The consumer can also refer other consumers to various promotions as shown in block 528, for example, by communicating information regarding the promotions to other consumers that have a relationship with the consumer. The consumer can also engage in various viral interactions through the promotion driven engagement network 102, including, for example, interacting with newsfeeds, and interacting with other social media networks to communicate information about promotions and other information derived from the online promotion driven engagement network 102.

In some embodiments, sponsors may communicate directly with advertisers in order to generate sponsorship agreements for promotions. For example, advertisers may create an auction platform and sponsors may enter bids for sponsorship of the promotion through the promotion network 200 or the online promotion driven engagement network 102. FIG. 6 illustrates a graphical user interface for communicating sponsor bid information according to some embodiments. As shown in FIG. 6, the advertiser bid interface 600 can be displayed to an advertiser that is conducting a promotion and can include an advertiser information display 602 (e.g., Company A as illustrated in FIG. 6), sponsorship type information display 604 (e.g., a rotating sponsorship type as illustrated in FIG. 6), and a promotion name display (e.g., corresponding to Contest X as illustrated in FIG. 6). The advertiser bid interface 600 can also display information regarding performance of the particular promotion (e.g., Contest X). For example, as shown in FIG. 6, the advertiser bid interface 600 can include an average promotion click through rate display 608 (e.g., 1.3% as illustrated in FIG. 6), and an average number of impressions for the promotion display 610 (e.g., 14,743 as illustrated in FIG. 6). The number of impressions may correspond to the number of instances that promotion was viewed by consumer devices, and the click through rate can correspond to the rate at which the consumers have engaged with advertisements that are included on the promotion page. Each of the displays shown in FIG. 6 can be dynamically updated based on interaction with the consumer.

The advertiser bid interface 600 can also include a bid status display 612. For example, as shown in FIG. 6, the advertiser may be provided with sponsor names (e.g., Tire Co. A, Watch Co. A, Aftermarket Parts Co. A, as illustrated in FIG. 6), as well as corresponding bids (e.g., $500, $400, and $150, respectively as illustrated in FIG. 6). The advertiser may interact through the advertiser bid interface 600 to select sponsorship bid winners (e.g., Tire Co. A, Watch Co. A) and may then enter into an agreement with the selected sponsors. For example, the advertiser may automatically collect payment from the sponsors upon including the sponsor's advertisements in the promotion.

FIG. 7 illustrates a graphical user interface for communicating sponsor bid notification information according to some embodiments. The sponsor bid notification information may be displayed to a sponsor through the promotion network 200 or the online promotion driven engagement network 102. The sponsor bid notification interface 700 can include a sponsor name display 702 (e.g., displaying Watch Company A as illustrated in FIG. 7), an outstanding bids display 704 (e.g., displaying 14 outstanding bids as illustrated in FIG. 7), and a promotion name display 706 (e.g., displaying Contest X as illustrated in FIG. 7).

Sponsor bid notification interface 700 can also include a sponsor bid status display 708. For example, sponsor bid status display 708 can include information regarding the outstanding bids by the sponsor. As illustrated in FIG. 7, the sponsor bid notification interface 700 can include advertiser name information (e.g., Car Co. A, Watch Retailer Co. A as illustrated in FIG. 7), corresponding promotion name information (e.g., Contest X, Contest Y, respectively, as illustrated in FIG. 7), corresponding bid cost information (e.g., $400, $1000, respectively, as illustrated in FIG. 7), and corresponding anticipated impressions information (e.g., 14,743 and 53,754 respectively, as illustrated in FIG. 7). The sponsor can interact through the sponsor bid notification interface 700 to add additional bids, remove bids, adjust bid price, or the like. Further, each of the displays shown in FIG. 7 can be dynamically updated based on interaction with the sponsor.

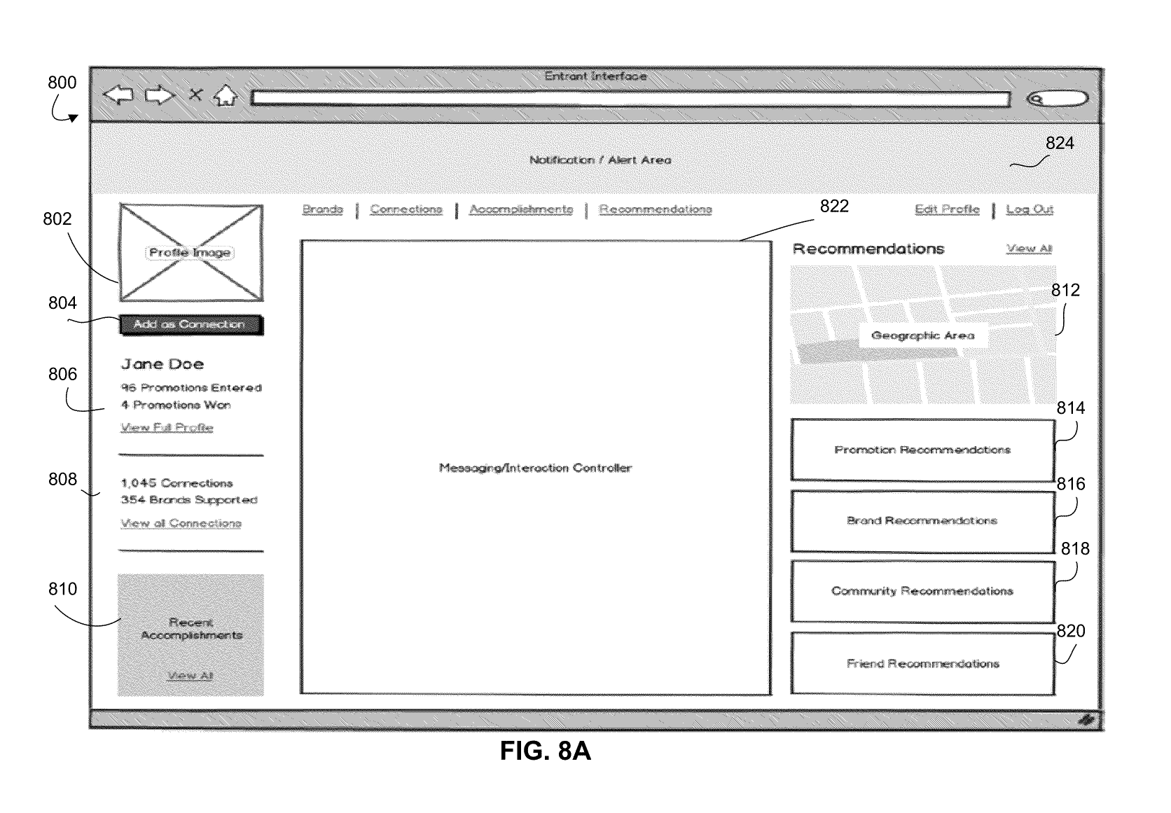

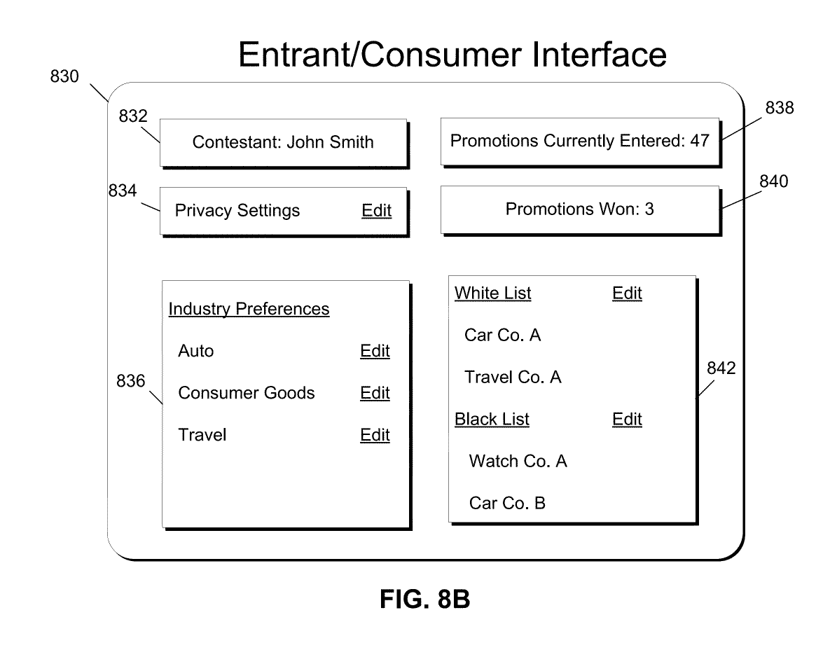

FIG. 8A illustrates one example of a graphical user interface 800 for an entrant/consumer. As shown in FIG. 8A, the interface 800 can include a profile image 802 of the entrant/consumer. The interface can also include a link to automatically generate a request to add the entrant/consumer as a connection as shown in block 804. As shown in field 806, the interface can indicate promotion participation information for the entrant/consumer. A link can also be provided to expand the view of the entrant/consumer's profile to include additional information. As shown in field 808, the entrant/consumer's connections and supported brand information can be provided. Additional information regarding the entrant/consumer's connections may be provided through interaction with a corresponding link. As shown in field 810, an entrant/consumer's recent accomplishments information can be displayed, and additional information can be accessed through interaction with a corresponding link.

The interface 800 can also include a recommendations section which can be based in part on geographic information that is identified by the entrant/consumer as shown in field 812. The recommendations can include promotion recommendations as shown in block 814, brand (e.g., advertiser/sponsor) recommendations as shown in block 816, community recommendations as shown in block 818, and friend (e.g., other entrants/consumers) recommendations as shown in block 820. The entrant/consumer can interact with the promotion driven engagement network through the interface 800 in order to establish online relationships, enter additional promotions, and control and update profile preferences and settings.

FIG. 8B illustrates another example of a graphical user interface 830 for an entrant/consumer. As shown in FIG. 8B, the entrant/consumer interface 830 can be used to communicate with an entrant of a promotion or a consumer through the online promotion driven engagement network 102. The entrant/consumer interface 830 can include a contestant name display (e.g., displaying contestant John Smith as illustrated in FIG. 8B), a privacy settings display 834, a display indicating a number of promotions entered (e.g., 47 as illustrated by display 838), and a display indicating the number of promotions which were previously won by the contestant (e.g., 3 as illustrated by display 840). The entrant/consumer can adjust the privacy settings by interacting with the entrant/consumer interface 830. Further, each of the displays shown in FIG. 8B can be dynamically updated based on interaction with the entrant/consumer. The entrant/consumer interface 830 can also include an industry preferences display 836. For example, the industry preferences display 836 can include consumer defined industry preferences (e.g., auto, consumer goods, and travel as illustrated in FIG. 8B). The consumer can adjust industry preferences by interacting with the entrant/consumer interface 830. The entrant/consumer interface 830 can also include a White List and Black List display 842 that indicates user preferences regarding particular companies. For example, as shown in FIG. 8B, the consumer prefers Car Co. A and Travel Co. B, and dislikes Watch Co. A and Car Co. B. The consumer can adjust the White List and Black List by interacting with the entrant/consumer interface 830.

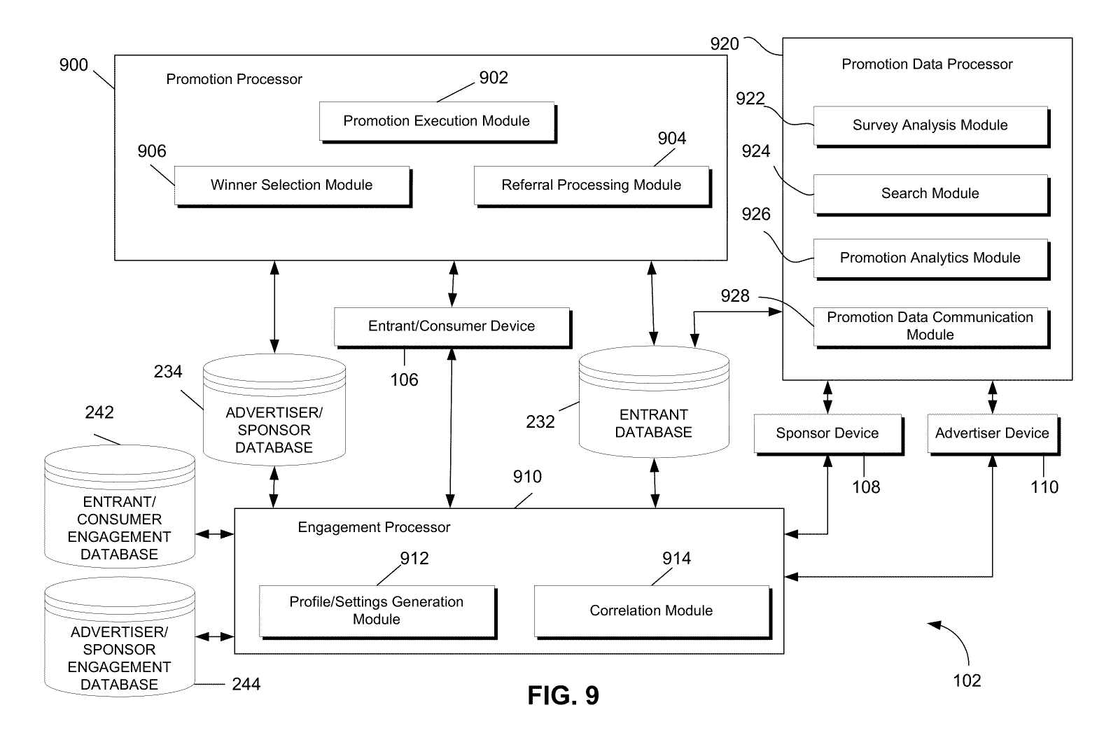

FIG. 9 illustrates examples of components of the online promotion driven network 102 of FIG. 1 according to some embodiments. As shown in FIG. 9, the online promotion driven network 102 includes a promotion processor 900, an engagement processor 910, and a data processor 920. While shown separately, the promotion processor 900, the engagement processor 910, and the data processor 920 may be configured as a single processor, for example, such as processor 100 as discussed above with reference to FIG. 2. The promotion processor 900 is configured to communicate with the advertiser/sponsor database 234 in order to retrieve information for generating a promotion. The promotion processor 900 includes a promotion execution module 902 configured to generate a promotion based on advertiser defined settings retrieved from the advertiser/sponsor database 234. The promotion execution module 902 is also configured to receive entrant information through communication with the entrant/consumer device 106. The received information that is retrieved through entrant participation in the promotion is stored in the entrant database 232. The promotion processor 900 also includes a referral processing module 904 configured to process referrals that an entrant has generated. The referral processor module 904 can determine the amount of credit that should be provided to the entrant for each referral based on settings defined by the advertiser and stored in the advertiser/sponsor database 234. For example, the referral processing module 904 may be configured to automatically generate a referral URL that is allocated to a particular entrant upon entry of the entrant in the promotion. The referral processing module 904 may then determine whether subsequent entrants have entered the promotion utilizing the referral URL. An entrant may be provided with additional opportunities to win a promotion based on the number of referrals that are determined by the referral processing module 904.

The promotion processor 900 also includes a winner selection module 906 which is configured to select a promotion winner based on participation of an entrant in the promotion. In some embodiments, the selection criteria may be preset by an advertiser. In some embodiments, the selected winner information may be stored by the winner selection module 906 in the entrant database 232 and the advertiser/sponsor database 234. The selected winner may also be communicated to, for example, other promotion entrants through the promotion driven engagement network 102 in order to promote additional participation in other promotions. In some embodiments, the selected winner information may be utilized in determining winner exclusion criteria for preventing particular entrants from winning the same promotion based on the terms of entry of the promotion.

The data processor 920 may include a survey analysis module 922, a search module 924, a promotion analytics module 926, and a promotion data communication module 928. The survey analysis module 922 may be configured to process entrant survey responses and determine relevant information for communication with a sponsor device 108 or an advertiser device 110. In some embodiments, the survey analysis module 922 may be configured to generate a graphical representation of global (e.g., cumulative and current) survey question responses and communicate the analyzed survey information through the promotion data communication module 928.

The search module 924 may be configured to enable searching and filtering of the data present in the entrant database 232 based on, for example, sponsor/advertiser defined search criteria to return particular information to the sponsor/advertiser. Sponsor/advertiser access to the information in the entrant database 232 may be restricted to information provided by entrants for the particular sponsor/advertiser's promotions. For example, entrant information which is retrieved through promotions that are unrelated to an advertiser may be restricted such that information provided to the advertiser is limited to the advertiser's promotions. In some embodiments, sponsors may also have limited access to the entrant information database 232 based on agreements between the sponsor and the advertiser, as well as the terms of entry for a particular promotion.

In some embodiments, the search module 924 may be configured to generate pre-set search criteria, such as filtering tools, based on answers to particular survey questions, entrant provided interests, entrant age information, entrant data entry into a promotion, entrant gender information, entrant location information, or the like. The search module 924 may also be configured to filter information in the entrant database 232 based on keywords provided by a sponsor/advertiser. The search module 924 may be configured to communicate results of the sponsor/advertiser defined search to the advertiser device 110 or the sponsor device 108 through the promotion data communication module 928.

The promotion analytics module 926 may be configured to analyze promotion results and communicate the analyzed results to the advertiser device 110 through the promotion data communication module 928. For example, the promotion analytics module 926 may graphically illustrate the number of impressions (e.g., views of the promotion by potential entrants), the number of unique impressions (e.g., views of the promotion by different entrant devices 106), the click through rate of particular advertisements, or the like. In some embodiments, the promotion analytics module 926 may be configured to generate a geographic view of promotion performance that is indicative of the number of entrants that have entered the promotion who reside in particular geographic locations. In some embodiments, the promotion analytics module 926 may be configured to generate a node view centered about a particular entrant. The node view may graphically illustrate entrants based on referrals that were generated from the initial entrant. The analyzed information can be displayed or communicated to the advertiser device 110 through the promotion data communication module 928. In some embodiments, the promotion analytics module 926 can generate data retrieved over multiple instances of the promotion, or across multiple promotions to aggregate and display lifetime promotion data to an advertiser through the promotion communications module 928.

The engagement processor 910 may be configured to control interaction between entrant/consumer device 106, sponsor device 108, and advertiser device 110 through the promotion driven engagement network 102. For example, the engagement processor 910 may be configured to control and enable communication between multiple entrant/consumer devices 106 utilizing information stored in the entrant database 232 which is retrieved through a previously entered promotion. The engagement processor 910 may include a profile/settings generation module 912. The profile/settings generation module 912 may be configured to retrieve additional information from entrants, consumers, sponsors, and advertisers, and store the additional information in the corresponding entrant/consumer engagement database 242 or advertiser/sponsor engagement database 244. For example, the additional information can correspond to information that is retrieved according to the methods described above with reference to FIGS. 4B and 5B.

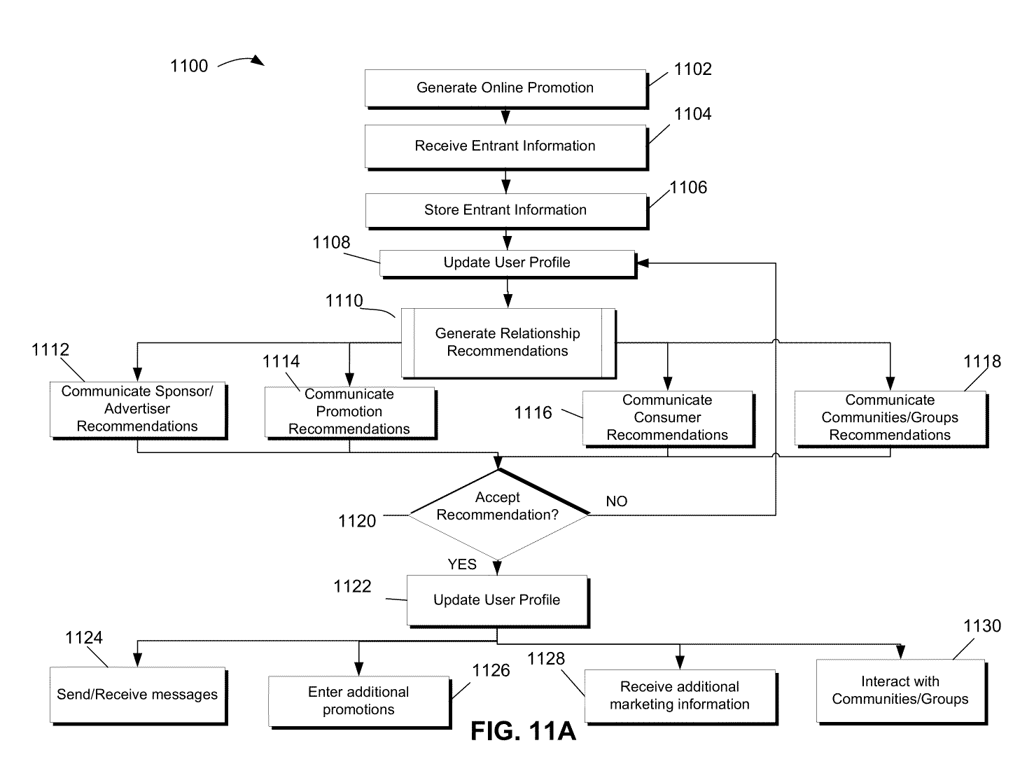

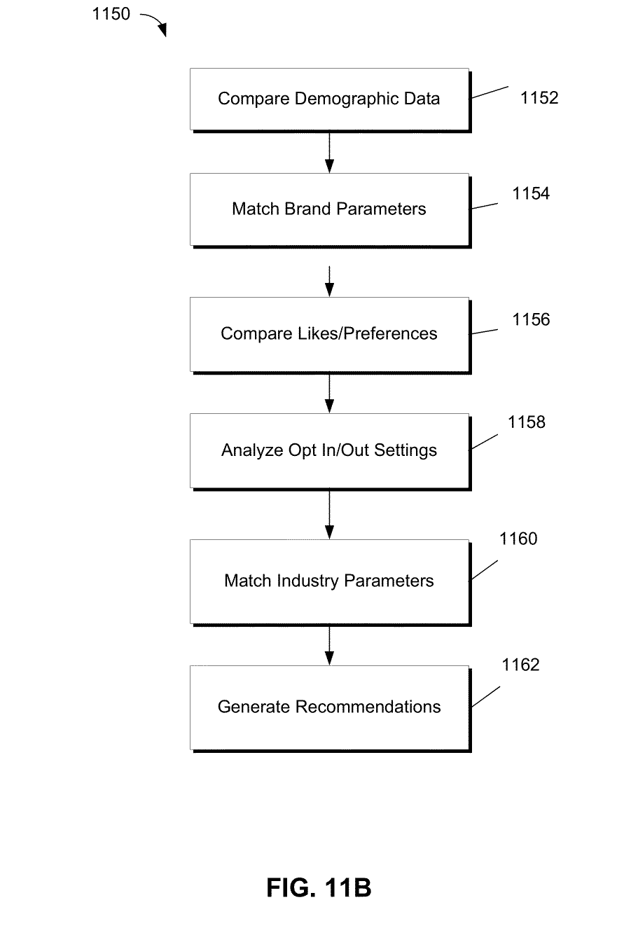

The engagement processor 910 can also include a correlation module 914. The correlation module 914 may be configured to determine relationships between entrants, consumers, sponsors, and advertisers based in part on information that is retrieved from the entrant/consumer engagement database 242 and advertiser/sponsor engagement database 244. The correlation of data to generate online relationships will be described in greater detail below with reference to FIGS. 11A-11B.

FIG. 10A illustrates an example of an entrant database according to some embodiments. As shown in FIG. 10A, entrant database 232 can include information for a plurality of entrants (e.g., Entrant 1-Entrant N). For each entrant, data that is retrieved through participation in a promotion is stored in the entrant database 232. For example, as shown in entrant information 233, the information can include a database ID (e.g., the entrant's record locator in the database), first name information, last name information, e-mail address, age, gender, and geographic location. The entrant information 233 can also include an influence score assigned to the entrant based on participation by the entrant in social media platforms. For example, if the entrant is particularly active in a number of social media platforms, or maintains a platform (e.g., a web-blog) which has exposure to a number of other potential entrants and consumers, the entrant is assigned a high influence score. The entrant information 233 can also include entrant defined interests (e.g., travel, cars, or the like), custom field responses (e.g., entrant birth date, phone number, or the like), survey question responses, entrant media entries (e.g., videos, music files, or the like), and a history of the promotions which have been entered by the entrant. In some embodiments, the entrant information 233 may also include information indicative of the most recent promotion activity of the entrant, and the frequency of activity of the entrant in promotions.

FIG. 10B illustrates an example of an advertiser/sponsor database according to some embodiments. As shown in FIG. 10B, advertiser/sponsor database 234 can include information for a plurality of advertisers (e.g., Advertiser 1-Advertiser N). While not shown, advertiser/sponsor database 234 can also include information for a plurality of sponsors that have not hosted a promotion.

As shown in FIG. 10B, for each advertiser, data that is retrieved during generation of a promotion is stored in the advertiser/sponsor database 234. For example, as shown in advertiser information 235, the information can include a database ID (e.g., the advertiser's record locator in the database), company name information, a company contact's first name and last name, address information, phone number, and a company website URL. The advertiser information 235 can also include promotion settings retrieved from the advertiser, survey questions used for promotions, custom field information for previous promotions, sponsor information, graphic content (e.g., logos), and promotion history information. The advertiser information can also include promotion analysis log-in information which enables access by the advertiser to promotion results.

FIG. 11A is an example flowchart of a method of utilizing promotion information to generate a promotion driven engagement network according to some embodiments. The method 1100 includes generating an online promotion as shown in block 1102. Entrant information is received from entrants as shown in block 1104. The received entrant information is stored in a database (e.g., entrant database 232 as discussed above). In some embodiments, based on the received entrant information, entrant access information (e.g., log-in information) for accessing the online promotion driven engagement network is generated and sent to the entrant.

At block 1108, a user (e.g., an entrant, a consumer, an advertiser, or a sponsor) profile may be updated based on additional information received from the user. For example, an entrant can indicate industry preferences or interests, which can be stored in a database (e.g., entrant/consumer engagement database 242) and used to update the user profile for interacting with the online promotion driven engagement network 102. At process block 1110, relationship recommendations may be generated based on the information stored in the database (e.g., the entrant/consumer engagement database 242 and the advertiser/sponsor engagement database 244). The correlations may be determined based on information that is received and stored from a plurality of different promotions having different participants. An example of the correlation process will be described in greater detail with reference to FIG. 11B.

The generated relationship recommendations may be communicated to a user. For example, sponsor/advertiser recommendations may be communicated as shown in block 1112, promotion recommendations may be communicated as shown in block 1114, consumer recommendations may be communicated as shown in block 1116, and communities/groups recommendations may be communicated as shown in block 1118.

At decision block 1120 it is determined whether the recommendations have been accepted by a user. If the recommendations have not been accepted, the method may return to block 1108 and the user profile can be updated based on additional information received from a user, or information that is received through additional promotion participation. In some embodiments, the method may include a learning mechanism which updates the user profile based on the recommendations which have been rejected and the recommendations which have been accepted by the user.

If it is determined that one or more of the recommendations have been accepted, the user profile is updated to reflect the established online relationship that is confirmed by the user as shown in block 1122. Following the update, online social interactions between the user and other users are performed based on the established online relationship. For example, messages may be sent and received directly between users having an established online relationship as shown in block 1124, additional promotions may be entered based on confirmed promotion or advertiser recommendations as shown in block 1126, additional marketing information can be received based on confirmed advertiser recommendations as shown in block 1128, and interaction between a user and other users of a confirmed community or group that has been recommended to the user may be performed as shown in block 1130. The established online relationship may provide a direct link for communication between the user and another user, and the established relationship information may be stored in a database (e.g., the entrant/consumer engagement database 242 or the advertiser/sponsor engagement database 244).

FIG. 11B is a flowchart of a method of correlating data to generate recommendations. The method 1150 includes comparing demographic data as shown in block 1152, matching brand parameters as shown in block 1154, comparing likes/preferences as shown in block 1156, analyzing opt-in/opt-out settings as shown in block 1158, and matching industry parameters as shown in block 1160. Based on the comparisons of user information, recommendations for online relationships can be generated as shown in block 1162. The method 1150 can include analyzing data stored in one or more databases, for example, the entrant database 232, the advertiser/sponsor database 234, the entrant/consumer engagement database 242, and the advertiser/sponsor engagement database 244.

In some embodiments, the method can include categorizing the stored information in the databases, assigning weights to the categories, analyzing the stored information in the database based on the assigned weights, and determining a level of correlation between a plurality of participants based on the analysis. For example, the method can include comparing the level of correlation with a threshold value, and generating an online relationship recommendation if the level of correlation is greater than the threshold value. In some embodiments, the level of correlation can also be communicated to the user to indicate the level to which the user's information matches the information of the recommended user. In some embodiments, a sales opportunity notification may be sent to an advertiser if the level of correlation is greater than the threshold value. The sales opportunity notification can be generated to automatically notify an advertiser of a potential sales opportunity based on the correlation results.

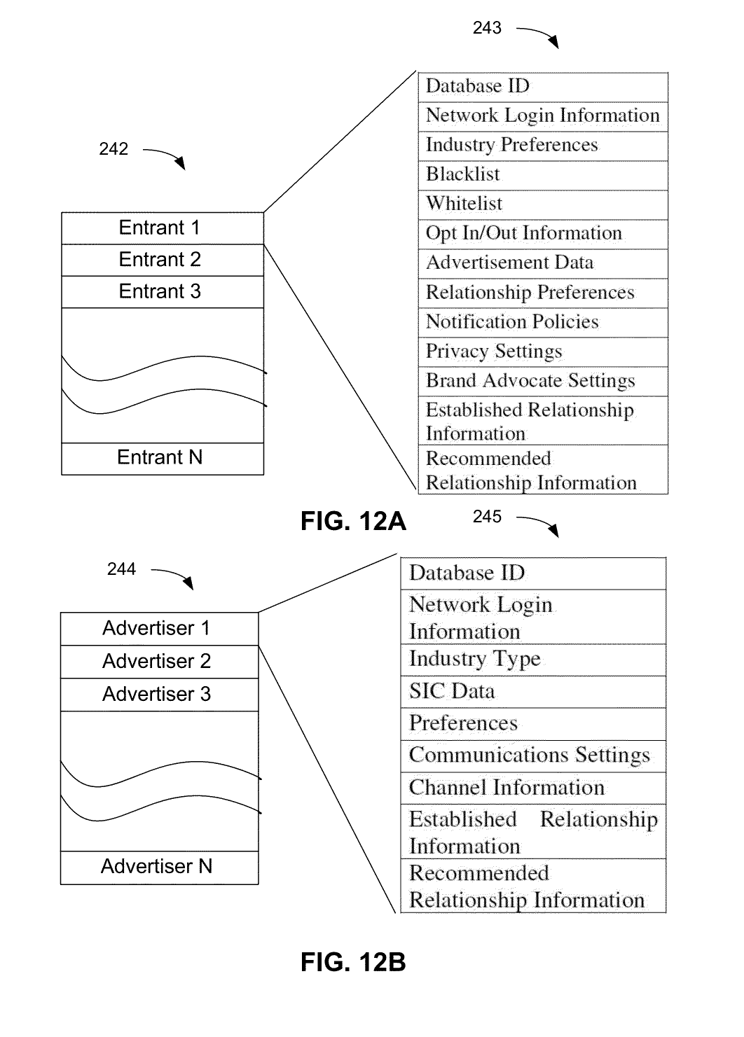

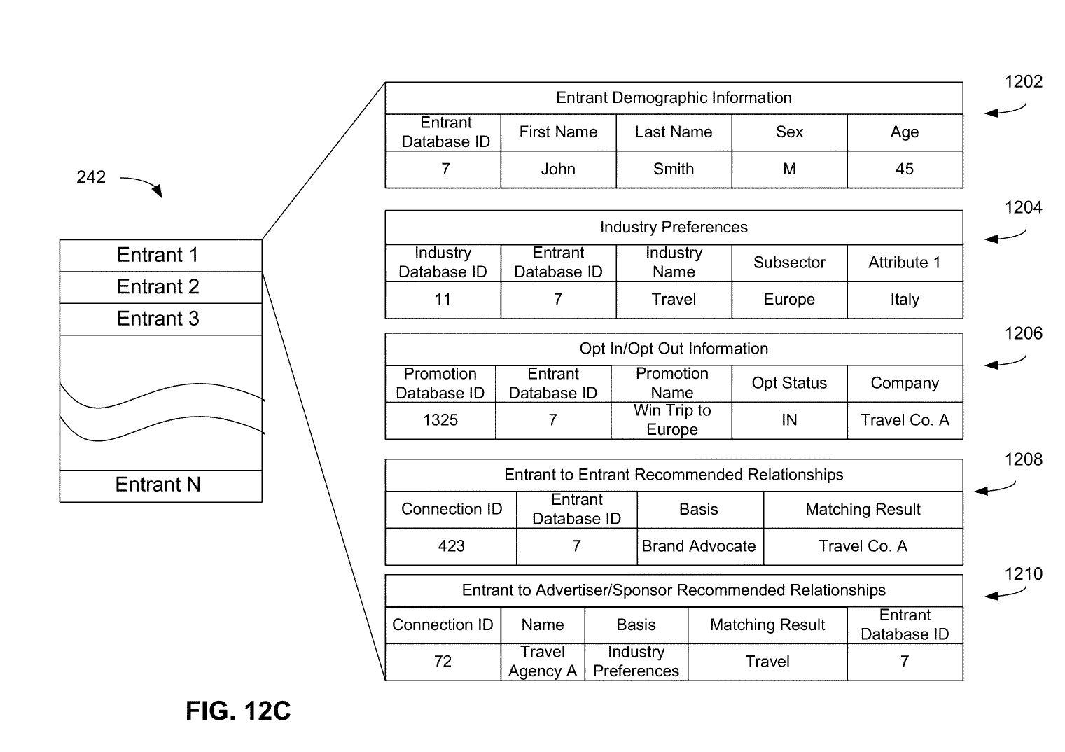

FIG. 12A illustrates an example of an entrant/consumer engagement database according to some embodiments. As shown in FIG. 12A, entrant/consumer engagement database 242 can include information for a plurality of entrants (e.g., Entrant 1-Entrant N). For each entrant, data that is retrieved through participation in a promotion is stored in the entrant/consumer engagement database 242. The entrant/consumer engagement information 243 can include a database ID (e.g., record locator in the database), network login information (enabling access to the online promotion driven engagement network 102), industry preferences, Black List information, White List information, and opt-in/opt-out information. The entrant/consumer engagement information 243 can also include advertisement data. The advertisement data can include information indicative of the advertisements that entrants have previously interacted with and/or information indicative of advertisement format preferences corresponding to the entrant. As shown in FIG. 12A, the entrant/consumer engagement information can also include relationship preferences, notification policies, and privacy settings. The entrant/consumer engagement information 243 can also include brand advocate settings indicating particular companies for which the entrant can be identified as a brand advocate based on participation in promotions and surveys. The entrant/consumer engagement information 243 can also include established relationship information, and recommended relationship information based on correlation of the data with other users as discussed above with reference to FIGS. 11A-11B.

FIG. 12B illustrates an example of an advertiser/sponsor engagement database according to some embodiments. As shown in FIG. 12B, advertiser/sponsor engagement database 244 can include information for a plurality of advertisers (e.g., Advertiser 1-Advertiser N). While not shown, advertiser/sponsor engagement database 244 can also include information for a plurality of sponsors that have not hosted a promotion. Similar to the entrant/consumer engagement information, the advertiser engagement information 245 can include a database ID (e.g., record locator in the database) and network login information for enabling access to the online promotion driven engagement network 102 by an advertiser. The advertiser engagement information 245 can also include industry type information, standard industry code (SIC) information, advertiser preference information, communication settings information, and advertiser channel information (e.g., information indicating the mode of communication that the advertiser uses for communicating advertisements with consumers). The advertiser engagement information 245 can also include established relationship information, and recommended relationship information based on correlation of the data with other users as discussed above with reference to FIGS. 11A-11B.

FIG. 12C illustrates an example of information retrieved from an entrant/consumer engagement database to generate recommended online relationships. As shown in FIG. 12C, an entrant/consumer's demographic information (e.g., corresponding to an entrant having database ID 7 as illustrated in FIG. 12C) can be retrieved as shown in table 1202. The entrant/consumer's industry preferences information can also be retrieved as shown in table 1204. For example, the entrant/consumer's industry preferences may indicate that John Smith enjoys to travel, prefers traveling to Europe, and in particular prefers traveling to Italy. The entrant (e.g., John Smith) may be correlated with the particular industry (e.g., travel) as identified in the database (e.g., Industry Database ID 11 as shown in table 1204). The entrant/consumer's opt-in/opt-out information may also be retrieved as shown in table 1206. For example, the entrant/consumer's opt-in/opt-out information may indicate that John Smith has entered Travel Co. A's promotion to win a trip to Europe, and that he remains opted in for the promotion. The promotion information may be retrieved as shown in table 1206 to identify the promotion based on a database ID number (e.g., promotion ID number 1325 as shown in FIG. 12C). Based on a comparison of the retrieved information with other users of the online promotion driven engagement network 102, recommendations can be generated for the entrant and can be stored in the entrant/consumer engagement database 242. For example, as shown in entrant recommendation table 1208, entrant to entrant recommendation information can indicate a connection ID that includes another entrant's database ID (e.g., record locator number in the entrant/consumer engagement database 242). For example, as illustrated in FIG. 12C, a recommended entrant may be identified as an entrant having database ID 423. The recommendation information can also include a basis of the recommendation (e.g., based on entrant 423's advocacy of Travel Co. A), which matches entrant 7's participation in Travel Co. A's promotion as shown in table 1206. The entrant recommendation table 1208 can also include information indicating the matching result (e.g., Travel Co. A) which can be stored and/or displayed along with the recommendation information.

As shown in advertiser/sponsor recommendation table 1210, entrant to advertiser recommendation information can indicate a connection that includes an advertiser or sponsor's database ID (e.g., record locator number in the advertiser/sponsor engagement database 244. For example, as illustrated in FIG. 12C, a recommended advertiser may correspond to database ID 72). The recommendation information can also include a basis of the recommendation (e.g., based on entrant 7's preference for travel), which matches the industry of Travel Agency A. The entrant recommendation table 1210 can also include information indicating the matching result (e.g., Travel) which can be stored along with the recommendation information. While not shown, similar recommendation information can be generated and stored for advertisers and sponsors.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

In one or more example embodiments, the functions and methods described may be implemented in hardware, software, or firmware executed on a processor, or any combination thereof. If implemented in software, the functions may be stored on or transmitted over as one or more instructions or code on a computer-readable medium. Computer-readable media include both non-transitory computer storage media and communication media including any medium that facilitates transfer of a computer program. A storage medium may be any available media that can be accessed by a computer. By way of example, and not limitation, such computer-readable media can include non-transitory computer-readable media including RAM, ROM, EEPROM, CD-ROM or other optical disk storage, magnetic disk storage or other magnetic storage devices, or any other medium that can be used to carry or store desired program code in the form of instructions or data structures and that can be accessed by a computer. A computer-readable medium can include a communication signal path. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium.

The system may include various modules as discussed above. As can be appreciated by one of ordinary skill in the art, each of the modules may include one or more of a variety of sub-routines, procedures, definitional statements and macros. Each of the modules may be separately compiled and linked into a single executable program. Therefore, the description of each of the modules is used for convenience to describe the functionality of the disclosed embodiments. Thus, the processes that are undergone by each of the modules may be redistributed to one of the other modules, combined together in a single module, or made available in, for example, a shareable dynamic link library.

The system may be used in connection with various operating systems such as Linux®, UNIX® or Microsoft Windows®. The system may be written in any conventional programming language such as C, C++, BASIC, Pascal, or Java, and ran under a conventional operating system. The system may also be written using interpreted languages such as Perl, Python or Ruby.

It will be appreciated by those skilled in the art that various modifications and changes may be made without departing from the scope of the described technology. Such modifications and changes are intended to fall within the scope of the embodiments. It will also be appreciated by those of skill in the art that features included in one embodiment are interchangeable with other embodiments; and that one or more features from a depicted embodiment can be included with other depicted embodiments in any combination. For example, any of the various components described herein and/or depicted in the figures may be combined, interchanged, or excluded from other embodiments.

What is claimed is:

1. An online promotion driven networking method comprising:
generating an online promotion;
receiving information related to the online promotion regarding a plurality of promotion participants, the promotion participants comprising a promotion entrant, an advertiser, or a sponsor;
storing the received information in a database;
correlating, via a computer processor, the stored information;
establishing online relationships between at least a subset of the plurality of participants; and
storing information indicative of the online relationships in the database.

2. The method of claim 1, further comprising categorizing the stored information in the database, assigning weights to the plurality of categories, analyzing the stored information in the database based at least in part on the assigned weights, and determining a level of correlation between a plurality of participants based on the analysis.

3. The method of claim 2, further comprising comparing the level of correlation with a threshold value, and generating a sales opportunity notification if the level of correlation is greater than the threshold value.

4. The method of claim 1, wherein establishing online relationships comprises communicating the correlated information with the subset of the plurality of participants, and receiving confirmation from at least two of the subset of plurality of participants that an online relationship should be established.

5. The method of claim 1, generating a promotion profile for each of the plurality of participants, receiving additional information regarding a generated profile from a participant associated with the generated profile, and editing the promotion profile based on the received additional information.

6. The method of claim 5, wherein the promotion profile includes privacy control information and online relationship information for the associated participant, and wherein the privacy control information includes at least one of advertiser black list information, participant contact information restrictions, or promotion opt-out information.

7. The method of claim 1, further comprising generating a participant profile associated with a first participant, and communicating the online relationship information via the generated participant profile via the internet.

8. The method of claim 1, further comprising determining a promotion winner based on a predetermined winner selection protocol.

9. The method of claim 1, further comprising compiling performance information indicative of the performance of the promotion, the performance information comprising at least one of a number of entrants, a number of impressions, or a number of unique impressions, analyzing the compiled performance information, and communicating the performance information to an advertiser or sponsor.

10. The method of claim 9, wherein analyzing the compiled information comprises determining a click-through rate based on the number of impressions and the number of entrants, and wherein communicating the performance information comprises generating a graphical representation of at least one of the click-through rate, the number of entrants, the number of impressions, or the number of unique impressions.

11. The method of claim 1, wherein generating an online promotion comprises receiving information from an advertiser via a sign-up form, and automatically configuring a plurality of promotion parameters based on the received information.

12. The method of claim 1, further comprising editing the online promotion via a WYSIWYG editing tool.

13. The method of claim 1, wherein generating an online promotion comprises automatically generating one or more widgets, an activity widget indicative of the activity of participants in the promotion, or a sponsorship widget configured to enable addition of sponsor advertisements.

14. The method of claim 13, further comprising generating user instructions for generating the one or more widgets.

15. The method of claim 1, further comprising receiving user generated content, distributing the user generated content to the plurality of participants via the internet, receiving feedback regarding the user generated content, and determining a promotion winner based on the received feedback.

16. The method of claim 1, further comprising receiving information from a referring entrant, receiving information from a referred entrant that is referred by the referring entrant, storing referral information indicative of the relationship between the referring entrant and the referred entrant.

17. The method of claim 16, further comprising determining a promotion winner based at least in part on the stored referral information.

18. The method of claim 16, further comprising analyzing the performance of the promotion based on the referral information, wherein analyzing the performance of the promotion comprises generating a node view of the information stored in the first database, and wherein the node view includes a node corresponding to the referring entrant.

19. The method of claim 1, further comprising analyzing performance of a plurality of promotions associated with a participant to generate performance information, and communicating the performance information to the participant.

20. An apparatus for online promotion driven networking comprising:
a database; and
a computer processor configured to:
generate an online promotion;
receive information related to the online promotion regarding a plurality of promotion participants, the promotion participants comprising a promotion entrant, an advertiser, or a sponsor;
store the received information in the database;
correlate the stored information;
establish online relationships between at least a subset of the plurality of participants; and
store information indicative of the online relationships in the database.

21. The apparatus of claim 20, wherein the computer processor is configured to categorize the stored information in the database, assign weights to the plurality of categories, analyze the stored information in the database based on the assigned weights, and determine a level of correlation between a plurality of participants based on the analysis.

22. The apparatus of claim 21, wherein the computer processor is configured to compare the level of correlation with a threshold value, and generate a sales opportunity notification if the level of correlation is greater than the threshold value.

23. The apparatus of claim 20, wherein the computer processor is configured to establish online relationships by communicating the correlated information with the subset of the plurality of participants, and receive confirmation from at least two of the subset of plurality of participants that an online relationship should be established.

24. The apparatus of claim 20, wherein the computer processor is configured to generate a promotion profile for each of the plurality of participants, receive customization information regarding a generated profile from a participant associated with the generated profile, and edit the promotion profile based on the received customization information.

25. The apparatus of claim 24, wherein the promotion profile includes privacy control information and online relationship information for the associated participant, and wherein the privacy control information includes at least one of advertiser black list information, participant contact information restrictions, or promotion opt-out information.

26. A computer program product for processing data for a program configured to generate an online promotion driven network, the computer program product comprising:
a non-transitory computer-readable medium having stored there code for causing processing circuitry to:
generate an online promotion;
receive information related to the online promotion regarding a plurality of promotion participants, the promotion participants comprising a promotion entrant, an advertiser, or a sponsor;
store the received information in a database;
correlate the stored information;
establish online relationships between at least a subset of the plurality of participants; and
store information indicative of the online relationships in the database.

27. The computer program product of claim 26, further comprising code for causing processing circuitry to categorize the stored information in the database, assign weights to the plurality of categories, analyze the stored information in the database based on the assigned weights, and determine a level of correlation between a plurality of participants based on the analysis.

28. The computer program product of claim 27, further comprising code for causing processing circuitry to compare the level of correlation with a threshold value, and generate a sales opportunity notification if the level of correlation is greater than the threshold value.

29. The computer program product of claim 26, wherein establishing online relationships comprises communicating the correlated information with the subset of the plurality of participants, and receiving confirmation from at least two of the subset of plurality of participants that an online relationship should be established.

30. The computer program product of claim 26, further comprising code for causing processing circuitry to generate a promotion profile for each of the plurality of participants, receive customization information regarding a generated profile from a participant associated with the generated profile, and edit the promotion profile based on the received customization information.

31. The computer program product of claim 30, wherein the promotion profile includes privacy control information and online relationship information for the associated participant, and wherein the privacy control information includes at least one of advertiser black list information, participant contact information restrictions, or promotion opt-out information.

32. A system for online promotion driven networking comprising:
means for generating an online promotion;
means for receiving information related to the online promotion regarding a plurality of promotion participants, the promotion participants comprising a promotion entrant, an advertiser, or a sponsor;
means for storing the received information in a database;
means for correlating the stored information;
means for establishing online relationships between at least a subset of the plurality of participants; and
means for storing information indicative of the online relationships in the database.
